(19) United States
(12) Patent Application Publication
(10) Pub. No.: US 2010/0141592 A1
(43) Pub. Date: Jun. 10, 2010

(54) DIGITAL CAMERA WITH CHARACTER BASED MODE INITIATION

(76) Inventors: Andrei Andrievsky, Webster, NY (US); Jason W. Blythe, Rochester, NY (US); Frank Marino, Rochester, NY (US); Jerald J. Muszak, Henrietta, NY (US); Michael J. Telek, Pittsford, NY (US); Richard M. Vogel, Pittsford, NY (US); Timothy J. White, Webster, NY (US)

Correspondence Address: EASTMAN KODAK COMPANY;PATENT LEGAL STAFF, 343 STATE STREET, ROCHESTER, NY, 14650-2201, US

(21) Appl. No.: 12/330,713

(22) Filed: Dec. 9, 2008

(51) Int. Cl. G06F 3/041; H04N 5/00

(52) U.S. Cl. 345/173; 348/333.02; 348/E05.001

(57) ABSTRACT

A digital camera includes a touch-screen for receiving individually or in any combination one ore more characters all of which are short-hand notation for corresponding camera modes or functions from a user; memory for storing one or more characters all of which individually or in any combination are short-hand notation for corresponding camera modes or functions; and a processor that receives the user input from the touch-screen and correlates the received input to one of the stored characters and directing the selected camera mode or function to initiate.

### FIELD OF THE INVENTION

The present invention generally relates to digital cameras and, more particularly, to digital cameras having a touch-screen that receives hand-written input from a user, such as letters of the alphabet, for indicating the desired camera mode.

### BACKGROUND OF THE INVENTION

Currently, digital cameras include a display for displaying images and various user interfaces for permitting the user to capture images, (still or video), displaying video or still images, setting operational functions such as manual or automatic mode and the like. The user manually operates the particular user interface by turning knobs or moving a dial for selecting the desired function. The camera then initiates the selected function.

Although the presently known and utilized camera is satisfactory, it includes drawbacks. Operating user interfaces sometimes present challenging situations for the user, particular those users who do not like remembering what particular knob or dial does what. This may cause the user to miss unique image capture opportunities because the camera is not in the correct mode.

US Publication 2008/0005703A1 uses hand gestures for launching a particular application on a PDA. Sensors are disposed of along the periphery of the PDA for sensing the hand gestures that are interpreted by the PDA for launching a particular application. This device uses a “training period” so that the gestures are known to the PDA. However, this method and system presents drawbacks since sensors must be added to the device which escalates the price. The downturn of the economy makes such expensive features undesirable. Still further, the particular hand gestures are individual to the person since training is required by the first user so that sharing a personal device is cumbersome and not user-friendly. Finally, devices like the present invention that use known technology, such as touch screens, to achieve improvements are more receptive to the general population since they are already familiar with the technology.

Consequently, the present invention ascertained that putting easily recognizable and well known characters that are easily identifiable with a particular mode of the camera, well known to all users, and easy to input would overcome these drawbacks.

### SUMMARY OF THE INVENTION

The present invention is directed to overcoming one or more of the problems set forth above. Briefly summarized, according to one aspect of the invention, the invention resides in a digital camera including a touch-screen for receiving individually or in any combination one ore more characters all of which are short-hand notation for corresponding camera modes or functions from a user; memory for storing one or more characters all of which individually or in any combination are short-hand notation for corresponding camera modes or functions; and a processor that receives the user input from the touch-screen and correlates the received input to one of the stored characters and directing the selected camera mode or function to initiate.

These and other objects, features, and advantages of the present invention will become apparent to those skilled in the art upon a reading of the following detailed description when taken in conjunction with the drawings wherein there is shown and described an illustrative embodiment of the invention.

### Advantageous Effect of the Invention

The present invention has the advantage of providing the user with a user-friendly mechanism for selecting the desired camera mode by using letters and symbols that are readily associated with the desired camera mode.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a camera of the present invention;

FIG. 2 is a back view of the camera of FIG. 1 illustrating the touch-screen with an exemplary letter that represents the desired camera mode;

FIG. 3 is also a back view of the camera of FIG. 1 illustrating another exemplary letter that represents the desired camera mode;

FIG. 4 is a table showing exemplary characters and their corresponding camera state; and

FIG. 5 is flowchart of the method of operating the present invention via software code.

### DETAILED DESCRIPTION OF THE INVENTION

Before describing the present invention, it is useful to understand the terms as used herein. In the regard, “character” is a symbol or mark used in a writing system.

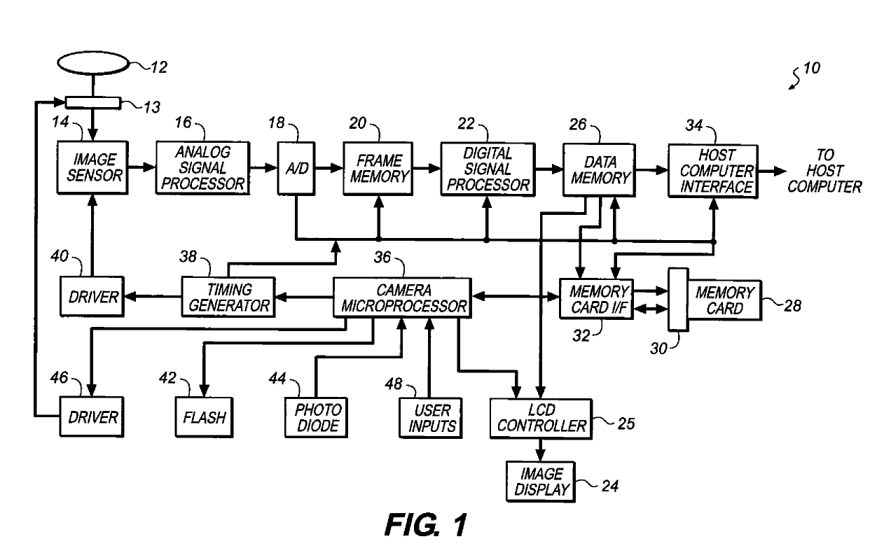

Referring to FIG. 1, a block diagram of an exemplary digital camera 10 in accordance with a first embodiment of the present invention is shown. As shown in FIG. 1, the digital camera 10 includes a lens 12 which directs image light from a subject (not shown) through an aperture/shutter controller 13 upon an image sensor 14 having a discrete number of photosensitive sites or pixels arranged in a two-dimensional array to form individual photosensitive sites corresponding to the pixels of the image. The image sensor 14 can be a charge coupled device (CCD) sensor or a complementary metal oxide semiconductor (CMOS) imager. The photosensitive sites of the image sensor 14 collect charge in response to incident. Each photosensitive site is overlaid with a color filter array (CFA), such as the Bayer CFA described in commonly-assigned U.S. Pat. No. 3,971,065, the disclosure of which is herein incorporated by reference. The Bayer CFA has 50% green pixels in a checkerboard mosaic, with the remaining pixels alternating between red and blue rows. The photosensitive sites respond to the appropriately colored incident light illumination to provide an analog signal corresponding to the intensity of illumination incident on the photosensitive sites.

The analog output of each pixel is amplified and analog processed by an analog signal processor (ASP) 16 to reduce the image sensor's output amplifier noise. The output of the ASP 16 is converted to a digital image signal by an analog-to-digital (A/D) converter 18, such as, for example, an 8 bit A/D converter which provides an 8 bit signal in the sequence of the Bayer CFA.

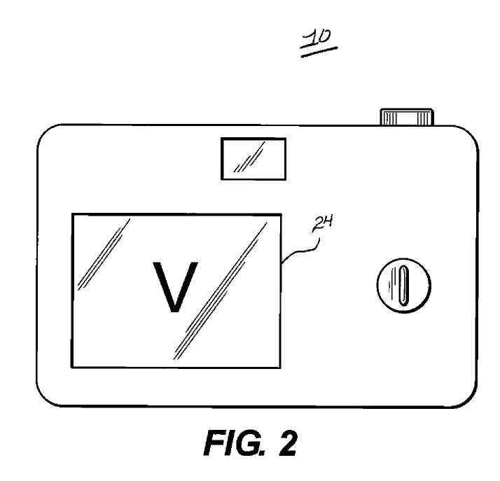

The digitized image signal is temporarily stored in a frame memory 20, and is then processed and compressed by a digital signal processor (DSP) 22. The image processing typically includes white balance, color correction, tone correction, and image sharpening. The DSP 22 also decimates (or re-samples) the digitized image signal for each still image to produce a thumbnail image having fewer pixels (i.e., lower resolution) than the original captured image as described in commonly-assigned U.S. Pat. No. 5,164,831 to Kuchta et al., the disclosure of which is herein incorporated by reference. The image file containing both the fill resolution image and the thumbnail image is stored in a data memory 26, and then transferred through a memory card interface 32 to a memory card 28 that is present in a memory card slot 30 of the digital camera 10. The thumbnail image is also sent to a touch-screen image display 24 through an LCD controller 25 where the user can view the image. Although the display is shown as an LCD display, OLED displays may also be used. The image display 24, which is shown in more detail in FIG. 2 and which will be discussed later, includes a conventional arrangement for displaying the captured image. The image display 24 may, alternatively, utilize many other types of raster image displays, including miniature CRT's, organic light emitting diode (OLED) arrays, or field emission displays.

The memory card 28 can be adapted to the PCMCIA card interface standard, such as described in the PC Card Standard, Release 2.0, published by the Personal Computer Memory Card International Association, Sunnyvale, Calif, September 1991. The memory card 28 can also be adapted to the Compact Flash interface standard, such as described in the CompactFlash Specification Version 1.3, published by the CompactFlash Association, Palo Alto, Calif, Aug. 5, 1998.

Electrical connection between the memory card 28 and the digital camera 10 is maintained through a card connector (not shown) positioned in the memory card slot 30. The memory card interface 32 and the card connector provide, e.g., an interface according to the aforementioned PCMCIA card or CompactFlash interface standard. The image file may also be sent to a host computer (not shown), which is connected to the digital camera 10 through a host computer interface 34.

In operation, a camera microprocessor 36 receives user inputs 48, such as from a shutter release (not shown), and initiates a capture sequence by signaling a timing generator 38. The timing generator 38 is connected generally to the elements of the digital camera 10, as shown in FIG. 1, for controlling the digital conversion, compression, and storage of the image signal. The camera microprocessor 36 also processes a signal from a photodiode 44 for determining a proper exposure, and accordingly signals an exposure driver 46 for setting the aperture and shutter speed via the aperture/shutter controller 13 and triggers a flash unit 42 (if needed). The image sensor 14 is then driven from the timing generator 38 via a sensor driver 40 to produce the image signal. The user inputs 48 are used to control the operation of the digital camera 10 in a well-known manner.

Referring to FIG. 2, there is shown a back view of the camera 10 of the present invention having an exploded view of the touch-screen display 24. The touch-screen display 24 serves a dual function—(a) displaying images and (b) permitting a user to input one or more characters for selecting the desired mode. In this regard, the processor 36 receives the user input and is programmed to correlate or recognize particular characters individually or in any combination (such as letters of the alphabet) that are input via the display 24. Memory 26 stores the one or more characters, and the processor 36 correlates these one or more characters to the received input for recognizing the desired camera mode or function. The processor 36 then initiates the selected camera mode or function. Each of these characters is preferably short-hand notation for a camera mode or function so that the entire word or words do not have to be spelled out in their entirety. It is noted for clarity that the characters in memory also individually or in any combination are short-hand notation for corresponding camera modes or functions. Still further, even though the English alphabet is used, other alphabets or characters may be used so that the characters are specific to the particular region of the world in which the camera is being used or sold. For example, Russian, Spanish, or French characters may be used.

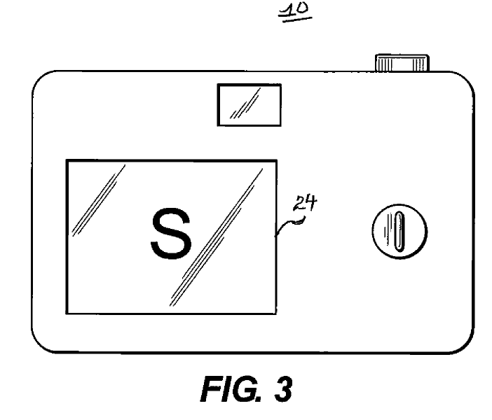

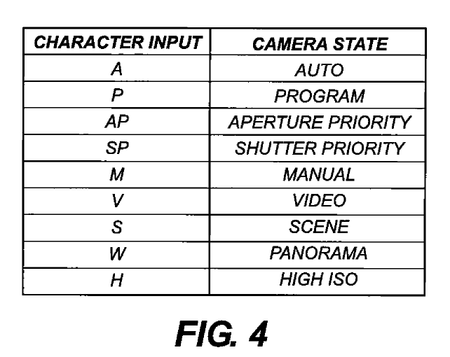

These characters may be recognized during particular modes, such as start-up and idle modes, for permitting the user to indicate what mode the user desires next for the camera 10. For example, the letter “v” (as shown in FIG. 2) is input to indicate “video mode” and the letter “s” (as shown in FIG. 3) is input to indicate still scene image mode. It is understood that these letters are exemplary and other letters or characters may be used to indicate these modes. Referring to FIG. 4, there is shown a table having exemplary characters and their corresponding camera state. The user uses either a stylus or their finger for touching and stroking movement therewith for inputting the particular character.

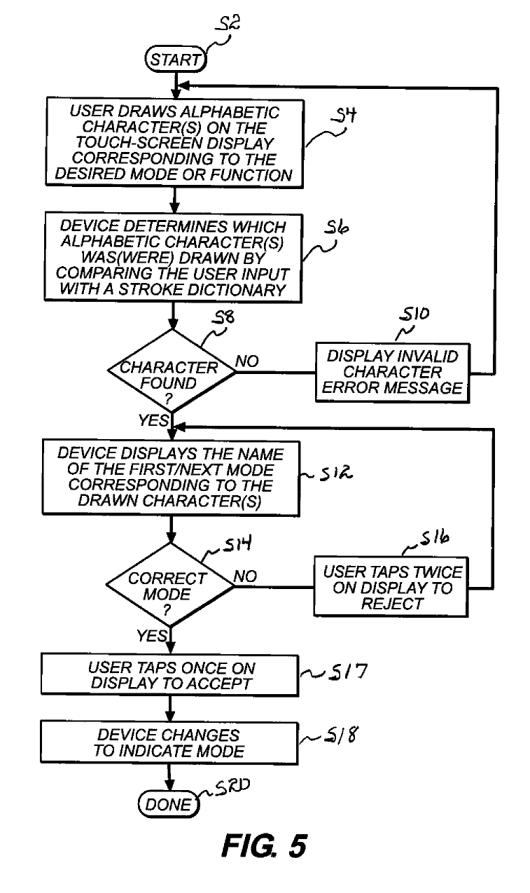

Referring to FIG. 5, there is shown a detailed flowchart of software code that is implemented by the microprocessor 36 for implementing the present invention. The software code is started S2 and the user inputs one or more characters (some of which are described hereinabove) on the touch screen S4. The one or more characters that are inputted are compared to a stroke dictionary S6 for determining if the one or more characters are valid. If the one or more characters are not found S8 (no state), the display displays an error message S10 and the screen is then returned to a blank state and permits the user to start over again. If the one or more characters are found S8 (yes state), the display displays the name of the first state having the designated one or more characters S12. It is noted that in some instances the inputted one ore more characters may have two or more results. For example, the character “s” may have the results of “still image” or “stop.” This step permits the user to decide between the two alternatives. If this displayed mode is not the desired mode S14 (no state), the user taps the touch screen twice S16 and the display displays the next mode corresponding to the inputted one ore more characters S12. If the displayed mode is the desired mode S14 (yes state), the user taps the screen once S17 and the camera then changes to the desired mode S18. This software code will terminate S20 when the digital camera 10 is turned off.

Although the present invention uses short-hand notation, the entire word or words may be spelled out in their entirety on the display, and in this case, the memory 26 the entire word or words so that the data input via the display and data stored in memory may be correlated.

The invention has been described in detail with particular reference to certain preferred embodiments thereof but it will be understood that variations and modifications can be effected within the spirit and scope of the invention.

### Parts List

10 camera
12 lens
13 aperature/shutter controller
14 image sensor
16 analog signal processor
18 A/D
20 frame memory
22 digital signal processor
24 image display
25 LCD controller
26 data memory
28 memory card
30 memory card slot
32 memory I/F
34 host computer interface
36 camera microprocessor
38 timing generator
40 driver
42 flash
44 photodiode
46 driver
48 user inputs

1. A digital camera comprising:
(a) a touch-screen for receiving individually or in any combination one ore more characters all of which are short-hand notation for corresponding camera modes or functions from a user;
(b) memory for storing one or more characters all of which individually or in any combination are short-hand notation for corresponding camera modes or functions; and
(c) a processor that receives the user input from the touch-screen and correlates the received input to one of the stored characters and directing the selected camera mode or function to initiate.

2. The digital camera as in claim 1, wherein the letter “v” represents video mode.

3. The digital camera as in claim 1, wherein the letter “s” represents still scene image mode.

4. The digital camera as in claim 1 further comprising a stylus for touching the touch screen.

5. The digital camera as in claim 1, wherein the touch-screen displays modes in sequence for the case in which some or all of the input characters are the same.

6. The digital camera as in claim 1, wherein the touch-screen is tapped in a first frequency for accepting a camera mode and tapped in a second frequency for rejecting a camera mode.

7. The digital camera as in claim 1, wherein the characters are English characters.

8. The digital camera as in claim 1, wherein the characters are non-English characters.
